(19) United States
(12) Patent Application Publication
(10) Pub. No.: US 2018/0322598 A1
(43) Pub. Date: Nov. 8, 2018

(54) PROPERTY MANAGEMENT SYSTEMS AND METHOD THEREOF

(71) Applicant: Building Information Management Systems Corporation, Bay Shore, NY (US)

(72) Inventor: Gregory A. Collins, Bay Shore, NY (US)

(21) Appl. No.: 16/039,483

(22) Filed: Jul. 19, 2018

Related U.S. Application Data
(63) Continuation of application No. PCT/US2017/022953, filed on Mar. 17, 2017.

(51) Int. Cl. G06Q 50/16; G06F 21/31

(52) U.S. Cl. CPC G06Q 50/163; G06F 21/31

(57) ABSTRACT

A property management system is disclosed herein. The property management system can include multiple components that operate therein, including a central management system, building management system, inspection management system, and a service management system. Using the property management system, an owner, other authorized representative, manager, tenant, building manager, inspector company and service company may efficiently communicate with each other, and upload reports and status updates directly to the respective systems. Each party may have authorization credentials to access information in the database that is commensurate with their authorization level. The systems and methods disclosed herein provide a convenient platform for the accumulation of data that can include data associated with real property, fixtures, chattel, etc.

### REFERENCE TO PRIOR APPLICATIONS

This application is a continuation of prior Application No. PCT/US2017/022953, filed Mar. 17, 2017, the entire contents of which is incorporated herein by reference.

### BACKGROUND

Property owners have significant tasks and jobs that need to be completed in order to properly and efficiently manage, organize, and track information about their properties and/or operate their business. An owner may have numerous tasks to be performed and/or issues to resolve, such as roof leaks, appliances breaking down, inspection requirements, etc. In addition, even if a building manager is employed it may still be difficult to track the amount of service orders outstanding at any one time, invoices that need to be paid, asset history, tenants who have outstanding balances, etc. Currently property owners do not have a central location to track, store and organize all their data related to a property including files, inspection history, management data, service history, assets, documentation, etc.

Furthermore, inspection and/or service companies that work with property owners and/or building managers may likewise have organizational, communication, and/or management issues. For example, a service company may employ numerous workers who are each at different job sites working on certain tasks. In this regard, in terms of cost-saving and being able to manage the workers efficiently, it is difficult to know where every worker is at all times, whether or not each worker is properly completing their tasks, etc. Additionally, when numerous service orders or inspections are completed, it may be difficult and time-consuming to track history, share information, prepare reports, generate invoices for each job, etc.

### SUMMARY

A system and method is disclosed herein that provides a property management system for an owner of a property to be able to electronically communicate via a single system with a building management company, inspection company, service company or other user on the system. For example, an owner of a property may access a website associated with the property management system, and claim his or her property. Upon doing so, the owner may also associate the one or more properties with a particular management company, inspection company, service company, and/or another user. In addition, a building manager or other authorized representative may be provided access to a portion of information related to the given property as well.

The owner, authorized representative, and/or authorized user may upload information into the database associated with the property management system. This information may pertain to mortgage information, insurance information and documents. Assets associated with the property, etc. In addition, the property management system can manage building management duties as well, such as tenant information, outstanding balances, due dates for payments, etc. The property management system may communicate directly with an inspection company, building superintendent, and/or a service company for various jobs and/or tasks that need to be performed. In this regard, inspections and/or service orders can be scheduled via an interface of the property management system, sent to the server, and then communicated between the owner or an authorized representative and the inspection, management, and/or service companies. The inspection and/or service companies can likewise communicate updates, invoices, reports, photographs, videos, etc. all pertaining to a particular task. Accordingly, the property management system allows for the complete management of one or more properties claimed by an owner or other authorized representative.

Each user of the property management system may access information in the database by entering proper credentials. In addition, once the proper credentials are entered, the amount of data that the given user is provided access to will depend on his or her position and authorization level. For example, the owner may be given access to all information associated with his or her properties. A building manager may be provided access to a portion of the information that is associated with the property, depending on the owner's preferences. For example, the owner may likely want the building manager to access inspection and service information, and building management information. However, the owner may not need the building manager to have access to mortgage or insurance documents with respect to the property. Finally, the service and inspection companies may only be provided access to the service and inspection data, respectively. In this regard, the inspection and service companies have no need to see data regarding the building management information, such as tenants' names, rent paid per tenant, etc. The reverse may also be true in that the inspection, service, and/or management companies may not always share data with the owner and/or other authorized representative.

The systems and methods disclosed herein provide a convenient platform for the accumulation of data. The data can include data associated with real property, fixtures, chattel, etc.

A property management system is disclosed herein, the property management system includes memory for storing property data received from a plurality of users; the property data including description data of the real property, asset data of assets associated with the real property, document data of documents associated with the real property, etc.; the plurality of users including an owner or authorized representative and at least one of an inspector and/or a service provider and/or a building manager; a processor connected to the memory, the processor configured to: determine if a user is an authorized user based on credentials input by the user; and when the user is an authorized user, identify a predetermined access level associated with the user, and provide the user access to the property data of the property management system, the access being consistent with the predetermined access level associated with the user.

A property management system is also disclosed herein, which includes a server connected to a network, the server including a memory for storing property data and a processor, the property data including description data of the real property, asset data of assets associated with the real property, document data of documents associated with the real property, etc.; a plurality of client devices connected to the network, the client devices configured to access the property data stored in the server by a user of a plurality of users, the plurality of users including an owner or authorized representative and at least one of an inspector, a service provider, and/or a building manager, the processor associated with the server configured to: determine if a user is an authorized user based on credentials input by the user; and when the user is an authorized user, identify a predetermined access level associated with the user, and provide the user access to a portion of property data of the property management system, the access being consistent with the predetermined access level associated with the user.

A method for managing property information is also disclosed herein, the method comprises the steps of: storing property data received from a plurality of users, wherein the property data including a description data of real property, asset data of assets associated with the real property, document data of documents associated with the real property, etc., and wherein the plurality of users including an owner or authorized representative and at least one of an inspector, a service provider, and/or a building manager; determining if a user is an authorized user based on credentials input by the user; and when the user is an authorized user, identifying a predetermined access level associated with the user, and providing the user access to a portion of the property data of the property management system, the access being consistent with the predetermined access level associated with the user.

### BRIEF DESCRIPTION OF THE DRAWINGS

FIG. 1 is an overview of a property management system in accordance with the present disclosure;

FIG. 2 is an exemplary system of claim 1;

FIG. 3 illustrates a client device inputting information into a browser and transmitting the information to a server in accordance with aspects of the present disclosure;

FIG. 4 illustrates property data associated with a property unit in accordance with aspects of the present disclosure;

FIG. 5 illustrates client devices communicating with the server in accordance with aspects of the present disclosure;

FIG. 6 depicts one of the client devices transmitting inspection data to the server;

FIG. 7 depicts one of the client devices transmitting service management data to the server; and

FIG. 8 is a flowchart of the various client devices transmitting information with the server.

Like reference numerals indicate similar parts throughout the figures.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Reference will now be made in detail to the exemplary embodiments of the present disclosure, which are illustrated in the accompanying drawings.

Below is a list of terms that are used throughout the present disclosure. The terms defined below are for explanation purposes and are not intended to limit the terms to only the definitions set forth below.
Asset: a chattel or fixture;
Asset History: information related to the history of an asset, e.g. repair history;
Authorized Information: the data and other information accessible by an individual user based on the user's access credentials;
Authorized User(s): a user account that is authorized by a higher or equal user level to access, modify, add, and/or delete portions of data accessible by one or more users;
Building: a structure with a roof and walls, including but not limited to an apartment complex, house, school, store, or other structure;
Building Management System: a component of the property management system, which may be accessed by at least a building manager and/or superintendent of a property;
Building Manager: high level user of the building management system;
Central Property Management System: a component of the property management system, which may be accessible by at least an owner, user, authorized representative, and/or tenant of a property;
Chattel: any property that would not remain with the real property in a real property transaction, the chattel may or may not be associated with a particular user, the chattel being owned by a chattel owner that can include a property owner, a tenant, etc.;
Client Device: an electronic device capable of processing instructions through which an authorized user can access the property management system;
Description data: a legal description of the real property, street address of the real property, GPS coordinates of the real property, square footage of the real property, and tax information of the real property;
Fixture: any property that would remain with the real property in a real property transaction, normally attached to the property;
Inspection Management System: a component of the property management system, which may be accessible by at least an inspector;
Inspector: an authorized user on the inspection management system;
Job: a task or piece of work;
Module: a component within a software program;
Owner: a high-level user of the central property management system (normally a real property owner);
Property: real and/or personal property;
Property Management System: a system to manage property, the system can include one or more of a central property management system, an inspection management system, a service management system, or a building management system;
Service Employee: a person that works for a service company;
Service Management System: a component of the property management system, which may be accessed by at least a service worker;
Service Order: a process that begins with a request to investigate and resolve a problem with an. asset, or replace or install a new asset or item in conjunction with the service management system;
Service Worker: an authorized user on the service management system;
Superintendent: an authorized user of the building management system;
System Administrator: user level who is responsible for the upkeep, configuration, and reliable operation of the property management system;
Tenant: a user of the central property management that is a renter of building/real property or a portion thereof;
User: any person that has proper credentials to access any portion of the property management system;
Work Order: a process that begins with a request to investigate and resolve a problem with a fixture in conjunction with the building management system; and
Worker: an employee, vendor, independent contractor, service worker, or service employee.

A property management system that manages and organizes assets associated with specific properties and the operation of properties is disclosed herein. The property management system provides varying access levels to particular types of users based on their association with the property, such as a property owner, building manager, inspector, service worker, tenant, etc. The amount of access provided to each user of the property management system depends on the security level associated with the given user. For instance, the owner of a property may be given full and complete access to all aspects of the property, whereas an inspector, building manager or service worker may be provided with access that is commensurate with their responsibility. Furthermore, each type of user may be able to view and/or upload information about a piece of property based on their level of access, such as service reports, tenant information, inspection reports, asset information, etc.

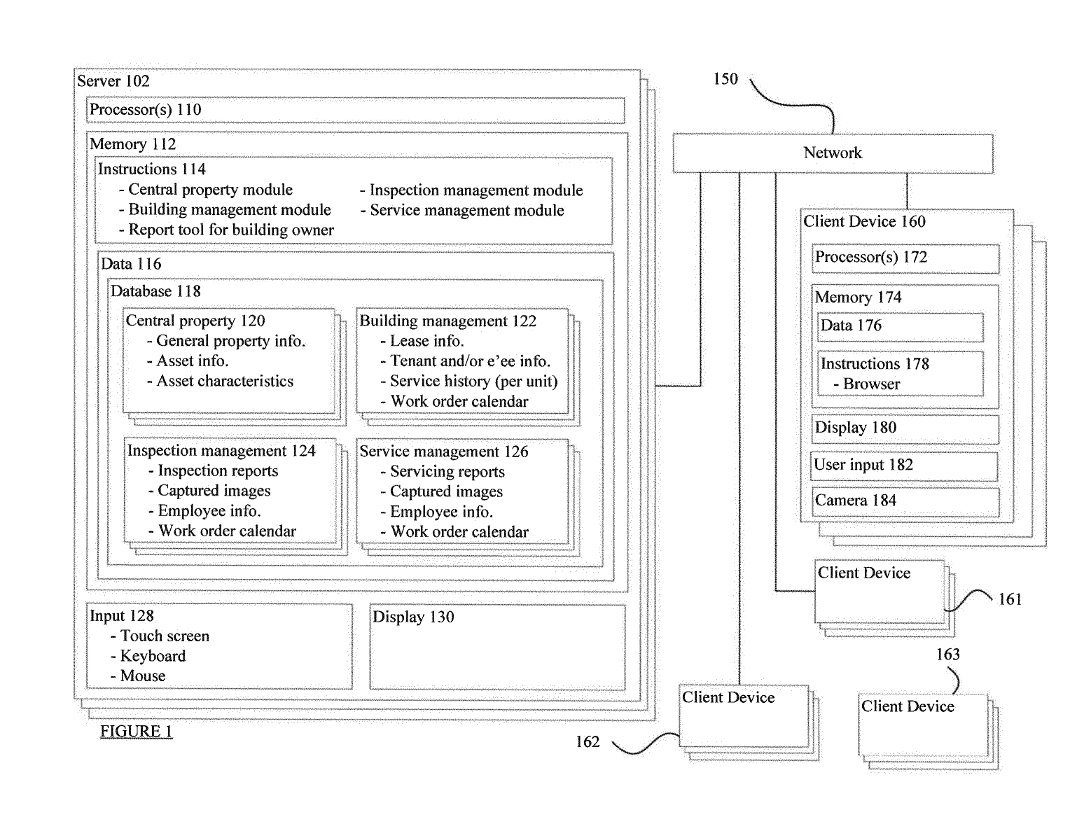

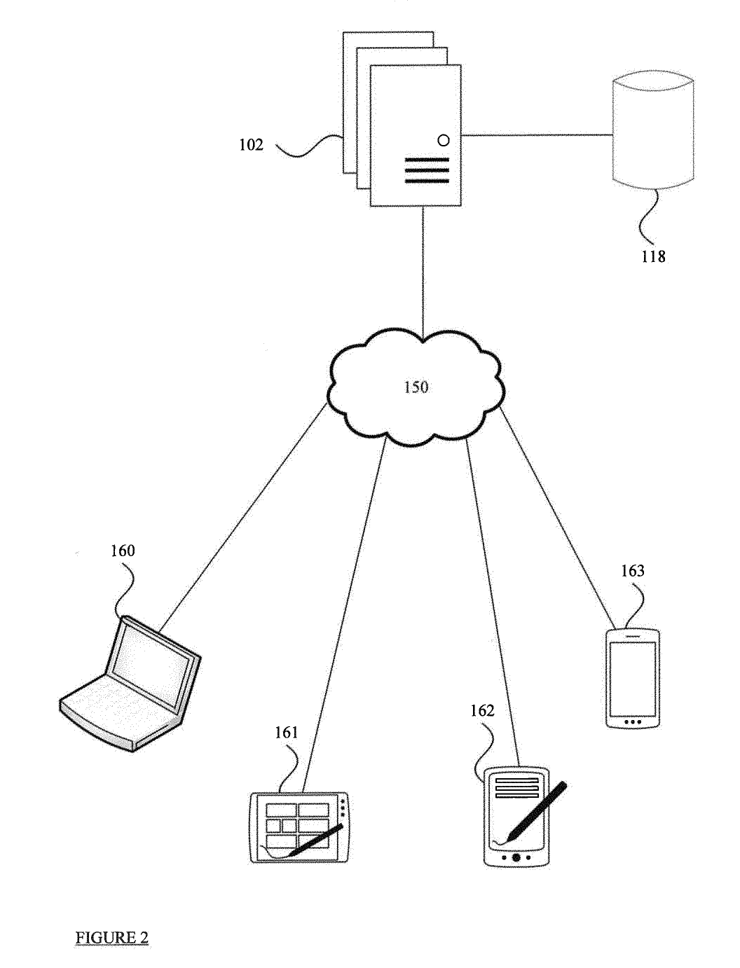

FIGS. 1 and 2 illustrate an example system of the above described property management system with various client devices. It should not be considered as limiting the scope of the disclosure or usefulness of the features described herein. In this example, the property management system includes server 102 and client computing devices 160-163 that communicate with server 102 via network 150. As depicted in FIG. 1, server 102 and client device 160 can contain one or more processors, memory, and other components typically present in an electronic device. Although not depicted in FIG. 1, client devices 161-163 may also contain one or more processors, memory, and components typically present in an electronic device.

With respect to server 102, memory 112 can include data 116 that can be retrieved, manipulated or stored by processor 110. Memory 112 can be of any non-transitory type capable of storing information accessible by processor 110, such as a hard-drive, memory card, Read Only Memory (“ROM”), Random Access Memory (“RAM”), Digital Versatile Disc (“DVD”), Compact Disc Read Only Memory (“CD-ROM”), write-capable, and read-only memories.

Instructions 114 can be any set of instructions to be executed directly, such as machine code, or indirectly, such as scripts, by processor 110. In that regard, the terms “instructions,” “application,” “steps” and “programs” can be used interchangeably herein. Instructions 114 can be stored in object code format for direct processing by processor 110, or in any other computing device language including scripts or collections of independent source code modules that are interpreted on demand or compiled in advance. Functions, methods and routines of the instructions are explained in more detail below.

Data 116 can be retrieved, stored or modified by processor 110 in accordance with instructions 114. For instance, although the subject matter described herein is not limited by any particular data structure, data 116 can be stored in computer registers, in a relational database as a table having many different fields and records, eXtensible Markup Language (“XML”) documents, or others. Data 116 can also be formatted in any computing device-readable format such as, but not limited to, binary values, ASCII or Unicode. Moreover, data 116 can comprise any information sufficient to identify the relevant information, such as numbers, descriptive text, proprietary codes, pointers, references to data stored in other memories such as at other network locations, or information that is used by a function to calculate the relevant data.

For example, as illustrated in FIGS. 1 and 2 data 116 is stored and organized within a database 118, which manages the various data stored therein. For example, database 118 includes central property data 120, building management data 122, inspection management data 124, and service management data 126, all of which will be discussed in more detail below. Furthermore, although FIG. 1 depicts database 118 stored within server 102, it should be understood that database 118 may alternatively or additionally be stored outside of server 102, as depicted in FIG. 2. In this regard, database 118 may be connected to server 102 via a physical wire to facilitate the transmission of data, or alternatively the sever 102 and database 118 may communicate over a network, such as network 150. Furthermore, multiple databases in addition to database 118 may be employed.

The information within database 118 depicted in FIG. 1 may be stored by various users that have the requisite security clearance and authorization level to read, write, and modify data stored in database 118. The users, for example, may be associated with one or more of client devices 160-163, which communicate with server 102 and database 118 over network 150.

Processor 110 can be any conventional processor, such as a commercially available Central Processing Unit (“CPU”), that is specially programmed to operate server 102 as described herein. Alternatively, processor 110 can be a dedicated component such as an Application-Specific Integrated Circuit (“ASIC”) or other hardware-based processor. Although not necessary, processor 110 may include specialized hardware components to perform specific computing processes, such as decoding video or sound, etc.

Server 102 may also include various input devices 128, such as a touch screen, keyboard or mouse as depicted in FIG. 1. Other input devices are also possible, however, such as a camera, microphone, etc. Furthermore, server 102 may include a display 130, such as a touch screen display or Liquid Crystal Display (“LCD”) that provides a user to physically view and thereby access the contents of server 102 or database 118.

Server 102 may be configured to communicate wirelessly over network 150, such as over Wi-Fi, a Local Area Network (“LAN”), Wide Area Network (“WAN”), Cellular Service, or the Internet. This may allow server 102 to communicate with client devices 160-163.

Client devices 160-163 may include a processor 172, memory 174, data 176, and instructions 178. As depicted in FIG. 2, client device 160 is a laptop computer. However, it should be understood that client device 160 may be any computing device capable of performing the functions described herein. For instance, client device 160 may be a personal computer, laptop, netbook, tablet, smart phone, smart watch or other wearable computing device, etc.

Memory 174 of client device 160 can include data 176 that can be retrieved, manipulated or stored by processor 172. Memory 174 can be of any non-transitory type capable of storing information accessible by processor 172, such as a hard-drive, memory card, ROM, RAM, DVD, CD-ROM, write-capable, and read-only memories.

Instructions 178 can be any set of instructions to be executed directly, such as machine code, or indirectly, such as scripts, by processor 172. In that regard, the terms “instructions,” “application,” “steps” and “programs” can be used interchangeably herein. Instructions 178 can be stored in object code format for direct processing by processor 172, or in any other computing device language including scripts or collections of independent source code modules that are interpreted on demand or compiled in advance. Functions, methods and routines of the instructions are explained in more detail below. As one example, instructions 178 include a browser application to allow client device 160 access the Internet, such as via network 150. This will allow the user operating client device 160 to access data within database 118.

Data 176 can be retrieved, stored or modified by processor 172 in accordance with instructions 178. For instance, although the subject matter described herein is not limited by any particular data structure, data 176 can be stored in computer registers, in a relational database as a table having many different fields and records, XML documents, or others. Data 176 can also be formatted in any computing device-readable format such as, but not limited to, binary values, ASCII or Unicode. Moreover, data 176 can comprise any information sufficient to identify the relevant information, such as numbers, descriptive text, proprietary codes, pointers, references to data stored in other memories such as at other network locations, or information that is used by a function to calculate the relevant data.

Processor 172 can be any conventional processor, such as a commercially available CPU. Alternatively, processor 172 can be a dedicated component such as an ASIC or other hardware-based processor. Although not necessary, client device 160 may include specialized hardware components to perform specific computing processes, such as decoding video or sound, etc.

In addition and as illustrated in FIG. 1, client device 160 may further include a display 180 and user input 182. Display 180 may be a touch screen display, LCD, etc. User input 182 may include one or more of keyboard, mouse, touch screen, etc. In addition, client device 160 may include or be in communication with a camera 184 so that a given user is able to capture images and upload such images to database 118. In addition, client device 160 may be able to upload documents and document data to database 118. Client devices 161-163 may similarly include a processor, memory with data and instructions, a display, user input, and a camera. These various components may function similarly as discussed above with respect to client device 160.

As disclosed in FIG. 1, database 118 includes central property data 120, building management data 122, inspection management data 124, and service management data 126. Although the data is described in these 4 categories, it will be seen that the system can include additional or differing data to handle differing requirements. Different users of the various computing devices 160-163 may have access to different data within database 118. For example, an owner of a property that is using client device 160 may have access to all relevant data related to his or her property. Furthermore, a building manager, an inspector, and a service manager may only be permitted access to building management data 122, inspection management data 124, and service management data 126, respectively. Even further, a system administrator that controls all aspects of server 102 may have complete access to all data for all the properties in database 118.

Referring first to the owner of a property that is using client device 160, the owner, using his or her client device 160, can access the property management system associated with server 102. In so doing, the owner can claim the property that he or she owns, such as by typing in a particular address and including an apartment number if necessary. For example, using the browser to access server 102 and database 118 associated therewith, the owner can type in the pertinent physical street address. Server 102 will then access database 118 and pull up the corresponding address. From here, the owner will be able to claim or otherwise select that address as being owned by him or her. From this point forward, that address in database 118 will be associated with the owner. It should be understood that other owners of property may similarly search for property on database 118 and then claim the property, such that the claimed property will then be associated with that particular user.

The owner may be subject to an ownership verification process as well. For instance, the verification process may include utilizing a third-party database and verifying that a particular individual or entity is associated with a particular property. Alternatively or in addition, the owner may be required to upload verifying details, such as a deed and personal identification (e.g., driver's license, passport) to the property management system, which may then be verified with the third-party database. The third-party database may store property records for a given geographical region. As on example, the Automated City Register Information System (“ACRIS”) as implemented in New York City, which provides property records and is accessible by the public via the internet. Other third-party databases that store property records may also be used, either collectively with other third-party databases or a single third-party database may be used.

After the owner has been associated or linked with his or her particular property, the owner is then provided with access to data that is associated with that property and any and all other properties owned by that particular owner. This information includes at least a portion of information depicted in database 118 of FIG. 1, which is exemplary only. For example, the central property data 120 includes general property information, asset information, asset characteristics, etc., which is described in further detail below.

The owner will be provided access to data associated with the one or more properties. Thus and as discussed in more detail below, the owner will have access to information as to the central property data 120, building management data 122, inspection management data 124, and service management data 126 associated with his or her property(ies). In this regard, the owner may be provided with access credentials that are verified by server 102 before owner is provided access to such data. For instance, the owner may set-up an account and thereby have to input access credentials. The access credentials may be a username and password, fingerprint authentication, iris scan, numerical code, alpha-numeric code, pattern, or any combination of each; other authentication technologies are contemplated. After entering the credentials, server 102 will compare the input credentials to pre-stored credentials to verify the identity of the owner. If the owner is properly authenticated, then the owner will be provided access to data associated with the property management system associated with his or her property. If the credentials of the owner are not validated by server 102, then the owner will be denied access thereto and may need to try to re-enter the proper credentials.

The general property information of central property data 120 may be information about the square footage of the property, plot measurements, year built, tax information, insurance forms, deeds, Certificate of Occupancies (COs), insurance certifications, surveys, pictures of the property, mortgage note documents and information, etc. Furthermore, a layout of the property may be uploaded to database 118 as well. The layout may be a text listing or provide a schematic, a 3-dimensional rendition, aerial view, etc., of the property that portrays the various rooms and sizes in the house relative to each other, any outside areas such as patios, decks, swimming pools, etc. Furthermore, the Asset data can be associated with particular locations, such as rooms or outside areas, of the house or property.

Asset information may include information about specific fixtures, items, chattel, things, etc. that are associated with the given property. For instance, appliances such as a stove, refrigerator, washing machine, dryer, iron, etc. In addition, other assets such as whether or not the property has a pool, deck, television, the type of flooring such as wood, carpet, tile, etc., information regarding the heating ventilation and air-conditioning system, and the roof.

Even further, particular data about each asset may be stored within database 118 as well, such as the year the asset was purchased, the make, model number, color, condition, service history, etc. of the asset. As an example, the year a stove or dryer was purchased may be stored inside database 118, in addition to any other known information about the product, such as the model number, make, color, condition, warranty, and service history associated with that stove or dryer. As another example, the year the roof was built and its condition, the make and year-built of the deck or pool, etc. All of this information for each asset may be collected and stored within a single database, in addition to asset history for each property being stored within database 118 as well.

The asset information that is stored within database 118 may be associated with the given user and/or property. For example, certain assets, such as refrigerators and stoves, may be associated with the property, so that when the property is sold or otherwise transferred or released to another owner, the refrigerator, stove, and other similar assets may transfer to the new owner as well. Alternatively, if a tenant is utilizing the property management system, then certain property may be associated with that particular tenant. For example, the tenant may own the air conditioner within the particular rental unit; therefore, when the tenant moves to a new location that air conditioner and other assets associated with that tenant will follow that tenant to the new location. Data that is stored in database 118 for each particular asset may be transferred. as well, such as service or inspection history, reports, etc.

The amount of storage space in database 118 that the owner is provided may be limited, but the owner may be provided the option to upgrade their membership for additional storage space. In this regard, database 118 may be a set amount of storage that the administrator will continue to grow when necessary, or database 118 may be cloud-based storage that automatically expands When necessary. As one example, there may be blocks of storage that a given user is authorized to buy, and the more or less of the amount of storage needed will be commensurate with more or less cost, respectively.

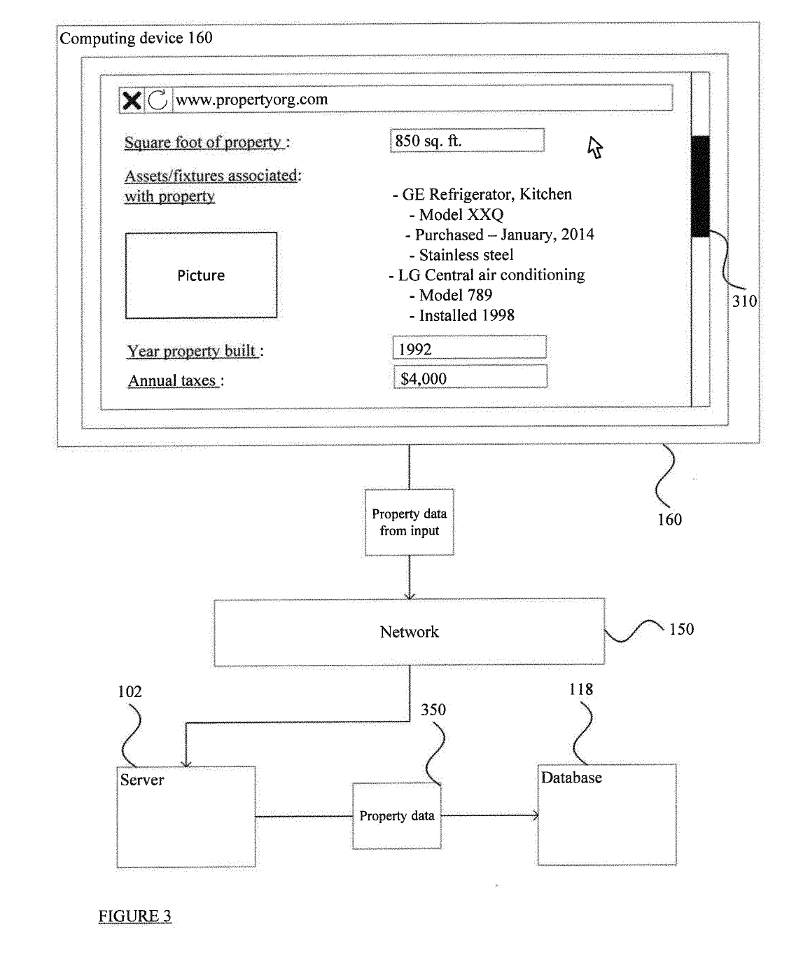

FIG. 3 provides an exemplary system of a user, such as an owner using client device 160, inputting information, such as via a keyboard, and uploading the information to database 118. In this example, the owner inputs information about the property, including 850 sq. ft. for square footage, a GE Refrigerator and LG central air conditioning for assets, 1992 for year built, and $4,000 for annual taxes. Furthermore, with respect to the GE Refrigerator, the user was able to input the model number XXQ, the date January 2014 for when it was purchased, a description of stainless steel, take and upload a picture, and upload a copy of the warranty. With. respect to the LG central air conditioning, the User was able to input model number 789, and that it was installed in 1998. Although only a few examples of various information input into client device 160 is provided in FIG. 3, it should be understood that the user may input more information for each asset or other aspects of the property, as discussed in the various examples above. For instance, the user may scroll down the page using scroll 310 to input other information in additional text boxes, drop down menus, etc.

After the data is input into client device 160, the data may save automatically, or the user may press a button to send, or otherwise transmit the data to server 102 and database 118. In this regard and as shown in FIG. 3, the data may be sent via a data packet 350 through network 150, to server 102 and ultimately to database 118. Although no network is shown between server 102 and database 118, it should be understood that database 118 may be coupled to server 102, connected via a wire or communicate over a network, such as over WiFi via a LAN, WAN, cellular, etc.

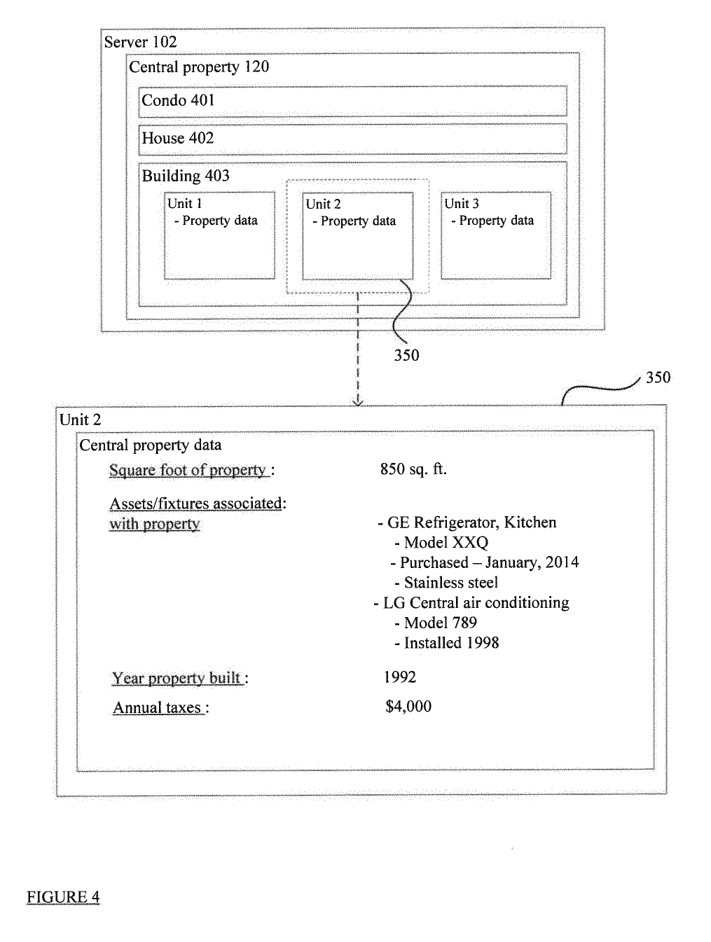

The property management system is also useful for a user to organize and manage multiple properties and assets associated with each of the properties. For example, FIG. 4 illustrates the data contained in database 118 that the owner input in FIG. 3 as being associated with a particular unit, such as apartment, of a particular building. In this example, property data 350 that was input by the owner in FIG. 3 is associated with unit 2 of building 403, as illustrated in FIG. 4. Furthermore, the user may also enter additional pertinent information for each unit contained in building 403, and for every other location as well, such as condo 401 and house 402. It should be understood that the owner of the various properties is not limited to any number of properties, types of properties, or units within properties, and may use the property management system herein for as many addresses and properties as necessary. In this regard, although FIG. 4 illustrates the owner owns a condo 401, house 402, and building 403, the owner may alternatively or additionally own a co-op, land, empty lot, townhouse, etc.

Various other authorized users will have access to certain data associated with a particular property. For example, an inspector may be provided with only inspection data associated with the property, and service workers that provide repairs or other work for a particular address may only have access to servicing data associated with the particular asset(s) or property. The building manager may be given restricted access to data associated with the given property as well, but based on the owner's discretion the building manager may be provided additional access that inspectors and service workers are not given. For instance, the building manager may want to see inspection reports and servicing reports in order to adequately manage the building. However, the owner may restrict the building manager's access in terms of mortgage notes, insurance information, etc.

Referring now to the building management system of the property management system, a building manager may be given an access to access data in database 118. For instance, if building 403 were to have tens or hundreds of units or apartments therein, then a building manager may be employed to manage the various units, apartments, or even multiple buildings if necessary.

Similar to the owner, the building manager will have to input proper credentials in order to access the requisite data in database 118. For instance, the system may use a username and password for authentication, fingerprint authentication, iris scan, numerical code, alpha-numeric code, pattern, etc., or any combination of each. Upon entering the proper credentials and being authenticated, the building manager may be provided access to various information contained within database 118. The amount of information that the building manager is provided access to of the central property management system may depend on how much access the owner or other authorized representative allows. In this regard, however, if the building manager is operating and managing one or more properties, it may be beneficial for the building manager to have access to a majority of the data within database 118, including access to a portion of the building management data, service management data, inspection management data, etc. that is directly associated with the subject property, as discussed in further detail below. For example, the building manager, superintendent, and/or tenant may need to request/submit/process/track work orders for inspections or service requests, such as to fix an appliance, roof leak, plumbing issue, etc. Furthermore, the building manager or other authorized representative may collect rent from tenants and manage tenant issues, if the property is a rental property, and other property issues. It should be understood that the owner may allow multiple users to have proper access credentials to access the database 118.

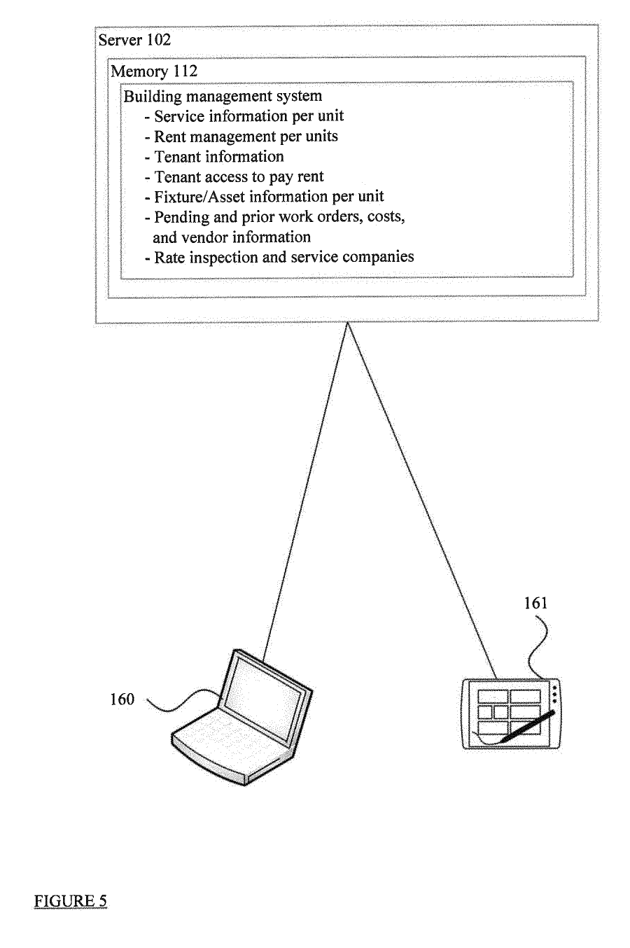

FIG. 5 provides an example of client device 160 being used by the owner and client device 161 being used by the building manager having access and viewing information with respect to building management data. Although client device 161 being used by the building manager is depicted in FIG. 5 as the building manager having access to the information, the building manager may alternatively not have access to such information. Alternatively, the owner may select which information contained within central property data 120 and accessible portions throughout database 118 is viewable or modifiable by the building manager or other user. For instance, the building manager may be able to only view certain information and not edit, other information may be viewable and editable by the building manager, and the building manager may be able to add and delete only certain information as well.

If the property is a rental property with one or more rental units, then the building manager may have access to tenant information inside database 118. The information or data may be stored as per each unit, such as each unit of each building will store data, to the extent available, associated therewith. For example, database 118 may store information regarding tenants' identities, rent information, lease documentation, which units have pets, etc. In addition, database 118 may store, collect, or utilize a payment gateway for payment information for a tenant so that tenants may set-up manual or automatic payments for rent, such as bank account information, credit card information, etc. Server 102 may also send alerts, such as to client computing devices, to remind tenants to pay rent and to alert the building manager as to who has or has not paid rent. The building manager or authorized representative may also access server 102, such as via a client computing device 161, and view or print reports as to which tenants paid or are late, outstanding balances, payment history per tenant, etc. Furthermore, the system may send additional alerts to the building manager a predetermined time period before a particular tenant's lease expires. This may prompt the building manager to obtain another signed lease from the tenant or begin searching for a new tenant. Other types of reports may be generated by server 102 with respect to building management data 122 as well, such as what percentage of the property is owned, vacancy rates, history of vacancy, history of tenants, etc. These reports may be generated upon request on server 102 or alternatively be automatically generated and then transmitted to the building manager, owner, and/or authorized representative, such as via e-mail, text message, document, spreadsheet, etc., Which the authorized user can access via client device 161.

Data stored in database 118 for building management 122 may further include service information that was performed at each unit or property. For example, if a work order was submitted for a worker to fix an appliance for a particular unit, then that information would be stored within building management data 122 of database 118. The building manager, superintendent or other authorized representative may be provided an opportunity to resolve the pending work order first. If the building manager is unable to resolve the pending work order, then the building manager may transfer the issue to a service order to be repaired by an outside service company. Alternatively or in addition, a service order may automatically be generated, thereby transmitting the issue to an outside service company.

If a service order was submitted for a company to fix a heater for a particular unit, that information may be stored within service management data 126 and or central property data 120. Nonetheless, a building manager with proper credentials will be able to access the authorized information regardless of which module that the data is stored within database 118. Furthermore, the respective tenant of a particular unit may submit a service request via the property management system. For instance, the tenant may submit a service request stating that there is a problem or issue in their particular unit. Issues may include that a particular appliance, such as a dryer, is not working, that the heat or hot water is not working, telephone is not working, or that there is a leak that needs to be fixed. This way, server 102 will log this data, report it to the building manager, superintendent, or other authorized representative and/or a service management company that may be associated with that particular property. The tenant's submission thereby creates a pending work or service order for the building management company and/or service management company to resolve. The owner, building manager, or other authorized representatives are able to see how much time passes before the work or service order is resolved. Furthermore, this streamlines the process by all authorized parties being alert of the situation and all authorized parties also being able to view the current status of the situation. In reference to a work order, a building manager and/or authorized representative can add notes, mark the request as solved or completed once verified, complete numerous related tasks, arrange for and schedule for a service company to resolve the problem, etc. The tenant may likewise be alerted to any corresponding status updates, such as a date being scheduled for a worker to resolve the problem, or that the task is completed and the problem has been resolved.

In addition, any service requests, notes, correspondences, status updates, dates of completion and more may be stored within database 118 and accessed by the building manager or other authorized representative. This data may be stored indefinitely or for a predetermined amount of time. Afterwards, reports may be generated either at the request of the authorized representative, such as the building manager, or automatically. These reports may detail open orders, closed orders, and performance processing. In addition, the user Who placed the order, owner, and/or building manager may review and rate the worker or service company's performance.

This system allows for the building manager, owner, and/or authorized representative to verify everything is being handled in a timely manner. For instance, if the worker or service company receives a service request that a problem needs to be fixed, such as a leaky faucet, then the building manager or authorized representative may contact the worker or service company if the problem is not resolved expeditiously. Similarly, the owner of the property is also provided access to this information and can become involved in the situation or process as well.

Referring now to the inspection management system of the property management system, a particular property may be associated with one or more particular inspection entity. Thus, should an owner wish to employ a particular inspection company, the owner, may select a particular inspection company to inspect one or, if applicable, more than one of the owner's properties. The inspection company may have previously signed up with the inspection management system so that owners are able to select them. Nonetheless, the owner of the property or authorized representative will need to authorize a particular inspection company, so that every inspection company does not have access to data associated with a particular property unless authorized to do so. Furthermore, owner may choose not to use an inspection company associated with the property management system.

The inspection companies may provide inspections to properties to verify a particular property is up to code and does not have any defects. For example, prior to purchasing a property an owner or authorized representative may hire an inspector or inspection company to check for any issues with the property that should be fixed or otherwise should be discussed during negotiations of purchasing of the property. The inspector may check for roof leaks, mold, termite damage, other potential structural defects, verify that the heating system such as the oil burner is working properly, verify central air is working, etc. The inspector may also provide recommendations on how to resolve certain issues. Alternatively or in addition, the inspection companies may be hired to log information and assets about a particular property. For example, instead of an owner or other user examining and cataloging each particular asset on the property and inputting such information into the property management system, an inspection company may be hired to do so. Furthermore, the inspection company may be hired for custom jobs, such as inspecting a pool, environmental inspection, etc.

An inspection company may use authentication credentials in order to access the inspection management system. For instance, the system may use a username and password for authentication, fingerprint authentication, iris scan, numerical code, alpha-numeric code, pattern, or any combination of each; other authentication technologies are contemplated. Upon entering the proper credentials and being authenticated, the inspector or inspection company may be provided access to various information contained within database 118. Since the inspector or inspection company likely only has use for the inspection information for the property, the property management system, after the user is properly authenticated, may only provide access to inspection management data 124 and in addition may be provided to particular data in central property data 120. The authorized users of the property management system will be provided partial access to the various modules within the system, and in particular data 120. Data 120 may provide layout to the system and asset information for the authorized user. Thus, data that is stored within inspection management 124 may be duplicate to central property data 120.

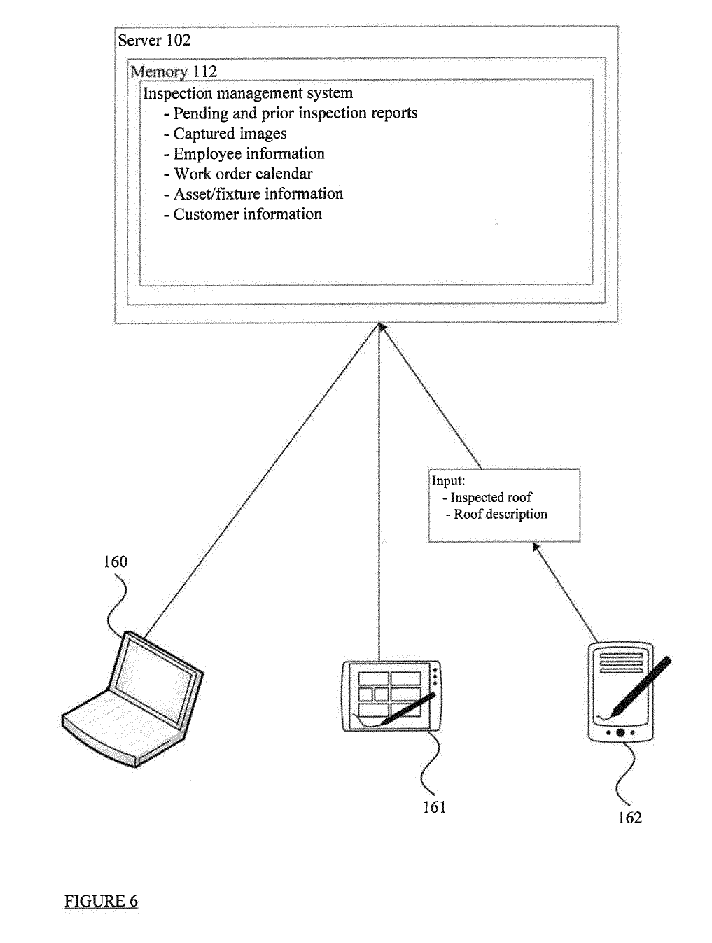

As shown in FIG. 6, the owner, building manager, and inspection company may be provided access, based on their authorized user levels, to inspection data within memory 112, via client devices 160, 161, 162, respectively. Since the inspection company only needs to know information about inspecting the given property or assets, they only need to be provided access to the inspection management system. Furthermore, since a building manager may be managing the given property, it would be beneficial for the building manager to have access to a portion of data from the inspection management system as well. The building manager, in addition to the owner, may be able to communicate with an inspector or inspection companies, see when inspections are scheduled, share information, receive reports, etc. It should be understood, however, that the owner has the option on whether or not a building manager has access to a portion of data from the inspection management system.

The property management system allows for a building manager or owner or other authorized representative to request an inspection, an authorized inspection management system user to schedule an inspection order, and then the inspector after performing the inspection can fill out a report and send to the client via the property management system. In particular, all of this information may be transmitted to server 102 via the respective client devices. For example, an owner operating client device 160 may place an inspection request and an inspection company may receive the request, such as on client device 162. Upon completion of processing the request to an order, scheduling and performing the inspection, the inspection company or worker may upload a report via client device 162, which is received by server 102 and may be subsequently transmitted to the client device of the owner, other authorized representative, and/or building manager.

Inspection management data 124 of database 118 may store all inspection reports and history of inspections and central property data 120 may store particular data of the inspection and/or the report in whole. All inspection data may be stored in both report and field format, so that the owner or other authorized representative can manipulate the fields for custom reporting.

The inspection management system may be a tool for inspection companies to utilize and manage their own workers as well. For instance, the inspection management system may include a custom tool to create custom workflows for different types of inspections for workers to use. Furthermore, as workers complete their inspections, the inspection management system may update in real-time so that all relevant parties, such as the inspection company, building manager, other authorized representative, and/or owner, are timely updated.

While conducting the inspection, the inspector may input information into his or her client device 162 about the property and/or asset and also capture photographs and/or videos using client device 162 or a camera. For example, FIG. 6 illustrates one example of the inspector using client device 162 uploading information over a network (not shown) to server 102 and database 118. Thus, the information, documents, and photographs may be uploaded to database 118. Furthermore, the information, documents, and photographs may be placed into a report template where the inspector or a manager can finalize the report before saving it and then sending the report to a customer, such as the owner or building manager. Furthermore, the text in the reports may be edited, removed, or text may be added; photographs and/or videos may be removed, reordered, or annotated on, such as to highlight specific points. Subsequently, all of the information is stored in database 118 of server 102.

The inspection management system may be a tool for inspection companies to monitor performance and efficiency of their company and share selected information of performance with their clients. For example and with respect to the inspection management system, processor 110 on server 102 may break down metrics by inspector, time frame, revenue, and other monetary valuations, travel radius, etc. Other information about inspections may be stored and shown as well, such as whether or not a contract for an inspection is waiting to be signed, whether or not an inspection needs to be scheduled, whether or not an inspection has a conflict, needs to be re-scheduled or cancelled, etc. Furthermore, data such as statistics on each inspector may be stored as well, such as how many inspections an inspector has performed, average time for completing an inspection, results after completing each inspection, etc. Owners, building managers, and/or authorized representatives may see pending inspection requests and/or orders and other information that is used to ensure that the inspections for the property and/or assets are adequately and timely performed.

All contracts may be created via processor 110 on server 102 as well, and then subsequently modified or edited by each respective party. Once the contract terms are finalized, the contract may be sent from server 102 to each party. Via the respective client devices, the owner, building manager, authorized representative, and/or the inspector may physically or digitally sign the contract and then upload the contract to server 102, which will then store the completed contract in database 118. Once the contract is executed, an inspector can quickly be assigned to the inspection and scheduled to go to the property via the inspection management system.

The information stored in database 118 may include customer information, including individual tenants, inspector data such as each inspectors name and which company each inspector is associated with, other vendor information, etc. All scheduled jobs may be stored within database 118 as well for each inspection company.

Also via the inspection management system the scheduled inspections can be synced with various calendars, such as Google® Calendar, iCal®, Outlook®, etc. Each inspector can have his or her own personal work calendar on a respective computing device, and managers of the inspection company are able to see full schedules. Furthermore, the building managers, owners, and other authorized representatives may be able to see all scheduled inspections that pertain to their properties.

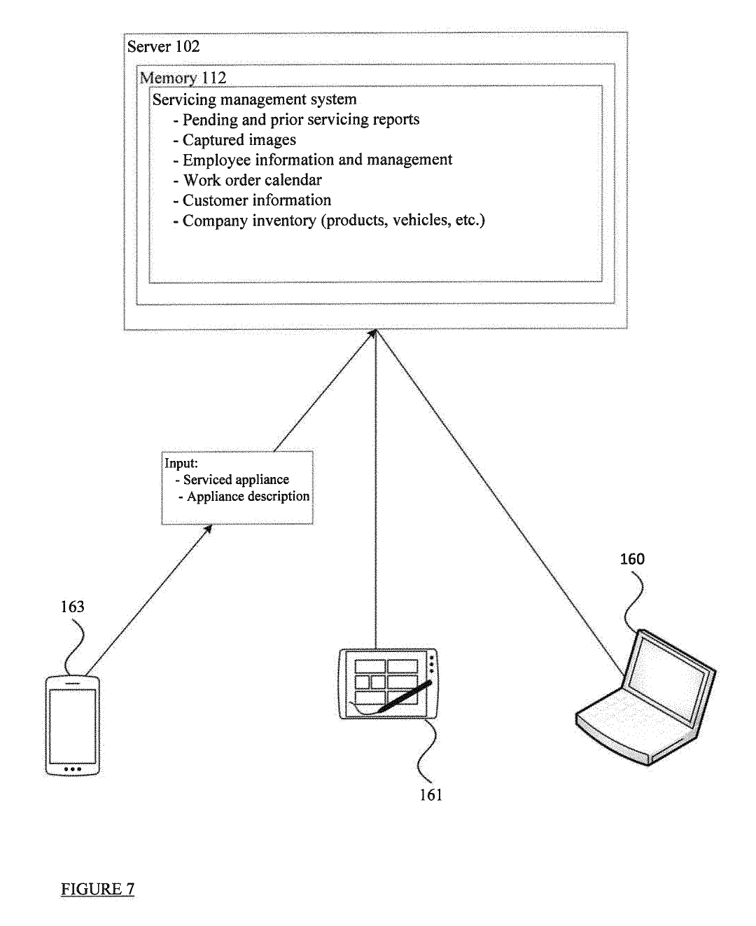

Referring now to the service management system, the service management system module may be in communication with the property management system as well. Alternatively, however, service companies may utilize the service management system by itself to manage their respective servicing businesses. FIG. 7 provides an example of some data that is stored in memory 112 for the service management system. The service management system may be configured to allow service orders to be requested, created and/or scheduled, track inventory, track worker time and tasks, and be an overall management system for service companies, which may be updated in real time for building managers, owners and/or authorized representatives with access rights to view.

Similar to the inspection management system, after the owner or authorized representative selects and claims one or more properties, then that owner or authorized representative may select to participate with a company utilizing the service management system as well. Furthermore, service companies may not have access to the particular property and/or asset data associated with a given property unless authorized to do so by the owner and/or authorized representative. This way service companies will not have access to a given property's property and/or asset data unless authorized. It should be understood that an owner may not select a specific service company immediately or at all, rather, the owner may choose not to use a service company associated with the property management system.

The service companies may provide services for any issues that are on a property. The services may include repairing or replacing a stove or other appliance, roof leaks or other structural damage to a building or unit, heating or air conditioning problems, etc.

A service company may use authentication credentials in order to access the service management system. For instance, the system may use a username and password for authentication, fingerprint authentication, iris scan, numerical code, alpha-numeric code, pattern, or any combination of each; other authentication technologies are contemplated. Upon entering the proper credentials and being authenticated, the service employee or service company may be provided access to various information contained within database 118. Since the service employee or company likely only has use for the servicing information for the property, the property management system, after the user is properly authenticated, may only provide access to service management data 126 and possibly to particular data in central property data 120. The authorized users of the property management system. will be provided partial access to the various modules within the system, and in particular central property data 120. Central property data 120 may provide layout to the system and asset information for the authorized user. Thus, data that is stored within service management 126 may be duplicate to central property data 120.

The owner, building manager, tenant, or authorized user are able to place a service order for a particular issue using the property management system. The issue may be a leaky faucet, heat or hot water not working, leak in ceiling, air conditioning not working, etc. The service order may be placed via a respective client device that is accessing server 102, such as via the website associated with the property management system. Once the request is processed and an order is placed by a party, the pre-selected service company may receive the order for processing. Alternatively, if the property is not set-up with a particular service company, then a service company may still receive the orders via the service management system if the user or tenant selects to utilize the services of a service management system already associated with server 102.

After a service order has been scheduled, the service company may use the service management system to assign a particular pending service order or task to a worker. When assigned, jobs may be automatically placed on the electronic work calendars of the client devices of each respective worker. The worker may see all pertinent information regarding the particular job on their client device as well. Scheduled jobs may likewise be modified, such as the text may be edited or the job may be assigned to another worker, etc. Jobs that have not yet been scheduled may also be shown on a display of a computing device such that the service company knows they still need to assign that job to a particular worker. In this regard, waiting lists may also be maintained for service orders that need to be scheduled. Service companies and their respective managers may transmit alerts to specific or all workers directly via the service management system as well, such as when a job is being scheduled, modified, or updated. Furthermore, all service orders may be tracked to verify that invoicing for each job is done prior to closing the service order or job. The service management system may also employ a master calendar so that managers of the service company are able to see each workers' work calendar and schedule for any given day or time period.

Workers may be managed by the service management system as well. For example, workers may clock in and out via the service management system on their respective client devices, such as smart phones, tablets, laptops, etc. Furthermore, the Global Positioning Systems (“GPS”) associated with each client device may be utilized via the service management system to track where a worker is located. This allows for the service company to know workers are where they should be at a particular time, whether or not a worker is taking longer than usual at a particular site, whether or not any other management decisions need to be adjusted based on the worker's location and status, etc. The servicing company may also see a detailed past history of each job a worker has worked on, in addition to future scheduled jobs, which may be used as a worker review tool.

Furthermore, the service management system may be used for workers to provide reports for each job they are assigned to. For instance, as shown in FIG. 7 the worker, after completing the job, uploaded information and/or a report to server 102 to be stored in memory 112 and database 118. These reports may include uploading photographs and/or videos, which may be taken via his or her client device 163, uploading documents and/or text reports that include what the issue was, what part or parts were used to fix the issue, how much time the job took, etc., This information may be associated with each worker and thereby provide a detailed overview of each worker in the system. All aforementioned uploaded information may be connected with the Asset being serviced to create a detailed history associated with that asset and thereby provide a detailed overview of each asset in the system. The asset history may be shared by the owner, building manager, and/or authorized representative with other service companies that may service that asset.

Based on the information that the worker uploads to the service management system, invoices may be automatically generated. For example, the invoices may be generated based on the amount of time that was entered by the worker for that particular job, parts that were used may be charged to the customer and included in the invoice, and any other requirements or resources that were expended as a result of the job. If the service management system is associated with a particular property, that invoice may be transmitted directly to the building manager, owner, or authorized representative. Once invoices are issued and paid, the service management system may be set-up to communicate with a particular company's accounting software or system as well. For example, the accounting system may be updated to show that an invoice has been sent, whether or not the invoice was paid, the amount of the invoice, outstanding balances, etc.

The service management system may also be an inventory management tool. Service companies may use the service management system to track all inventory in their warehouses; this way, service workers and companies know whether or not they have the requisite materials, parts, or tools in stock to work on a particular job. Service companies may order supplies and then use the service management system to upload each part that has been ordered. Upon receipt, the service company can check off and update their inventory as being received. Thus, when a service worker is out in the field or before a job is even scheduled, the worker or service company can verify in the service management system whether or not they have the necessary part. If the part is in stock, then the job may be scheduled early, if the part is not in stock then the company may order the part.

Vehicles used by each worker may be tracked and managed by the service management system as well. For example, company vehicles may be tracked, such as mileage, employee drivers assigned to each particular vehicle, jobs that each respective vehicle was used for, maintenance requirements or check-ups that may be needed for each vehicle such as tire replacement, brake checks, change the oil, etc.

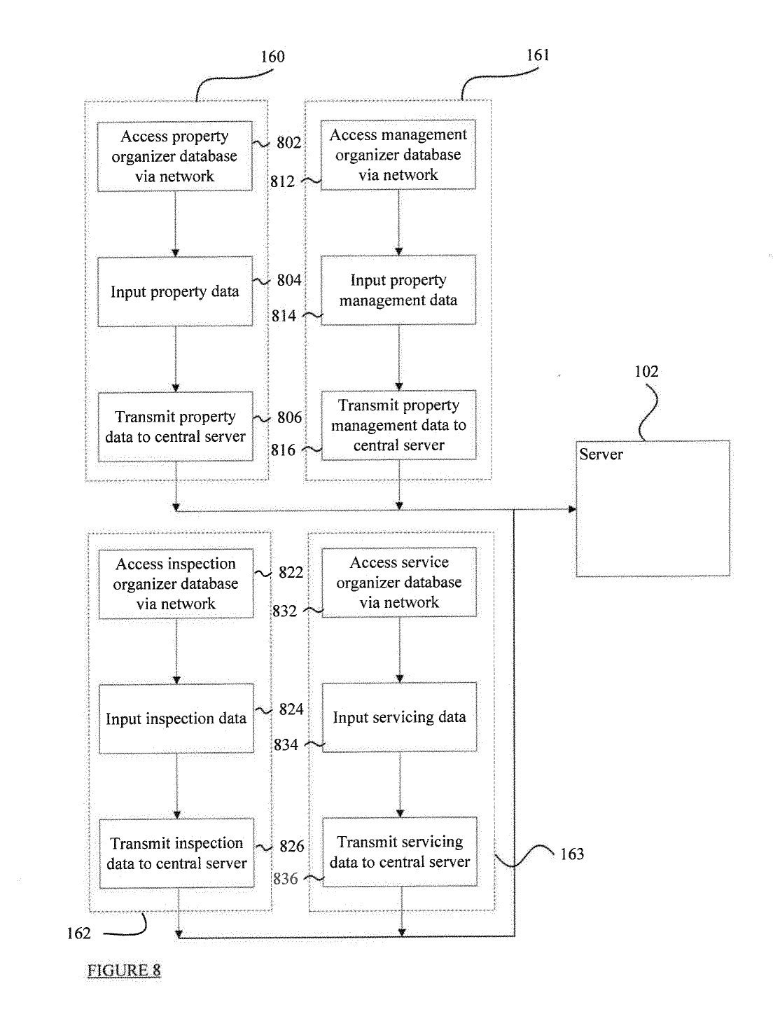

FIG. 8 provides a schematic flowchart of the processes of each computing device 160-163. For example, the owner, building manager, inspector, and service worker accesses the respective property management system at steps 802, 812, 822, and 832 via client computing device, 160, 161, 162, and 163, respectively. Specifically, the owner accesses the central property management system as a whole, the building manager accesses the building management system, the inspector accesses the inspection management system, the service employee accesses the service management system, and additional user levels are available within each module. It should be understood that the various systems may be sub-systems of the property management system. Each user must be properly authenticated in order to access the respective system. For example, each user inputs their credentials, such as a username and password, fingerprint authentication, iris scan, numerical code, alpha-numeric code, pattern, or any combination of each; other authentication technologies are contemplated. Once the user is properly authenticated, they will be permitted to access a certain degree of data on database 118. For example, the user will be provided access to information that is commensurate with their particular duties and as authorized. The owner may be provided with all information for his or her properties, and the building manager may be provided access to relevant information associated with the properties depending on what the owner permits. However, the inspector and. service employee may only be permitted access to information pertaining to the inspection systems and data and the service systems and data, respectively as well as any other authorized information such as property layout, asset data, etc. In this regard, the inspector and service employee will generally have no use for information pertaining to any of the other systems, especially the private information concerning tenants, mortgage notes, etc.

At steps 804, 814, 824, and 834 each user will then input the requisite data. For example, the owner using client device 160 may input property data, such as mortgage information, square feet of property, assets associated with each property, insurance information and documents, etc. The building manager using client device 161 may input information such as rent management for tenants, tenant information and history, lease documents and information, service orders communicated with the service management system, etc. The inspector using client device 162 may input information about an inspection, such as information regarding the inspection, reports, photographs, documents, time to complete the inspection, etc. And the service employee using client device 163 may input information regarding the servicing, such as the problem at the scene, details regarding how the issue was resolved, photographs, parts that were used, and time spent at a particular address to fix the issue, etc.

Finally, at steps 806, 816, 826, and 836 the inputted data is transmitted to server 102 for processing and storage. For example, the property information input by the owner may be stored in database 118 and associated with that particular property. The data input by the building manager may likewise be stored in database 118. Furthermore, if the building manager entered a service order, then the server may subsequently process that order and transmit the order request to the service company, assuming the given property has selected a service company to be set-up through the property management system. The information input by the inspector and service employee may likewise be uploaded and stored within database 118. Furthermore, the data and reports uploaded may be accessible and viewed by the respective inspection company and service company. Reports may ultimately be transmitted to the owner, building manager and/or authorized representative for review as well.

As a further embodiment, the various data stored relating to the assets associated with each property may be used to transmit pertinent advertisements to users, such as an owner. For instance, since database 118 of the property management system stores all asset data, companies that manufacture or service the assets may send advertising and marketing materials to owners thereof. As one example, information stored in database 118 may be beneficial for a company such as General Electric® (“GE®”). GE® may then use that information through the property management system to send servicing materials or advertising and marketing materials to the people who own GE® products. In one scenario, if GE® is apprised that an individual owns a GE® refrigerator that is thirty years old, GE® may send through the property management system to that individual communication on newer refrigerators that are more energy efficient, any recalls that may be associated with that refrigerator, service and repair updates and advertisements, etc.

As another example, service companies that service or repair assets may be able to send advertising and marketing materials to owners of the assets as well. A servicing company that is provided pertinent data within database 118 may use that information to generate additional business. For example, a servicing company that services washing machines and dryers can send advertisements through the property management system to owners that they are well versed in repairing such machines.

The advertisements, marketing materials, or any communications that are transmitted may be transmitted via e-mail, text message, a message or communication within the property management system itself, etc.

As another embodiment, the property management system may provide communications between and among the various connected and authorized representatives of the system. For example, employees of a servicing company may use the service management system to communicate between each other. In addition, a tenant may communicate with an owner or building manager using the property management system. The owner of a property may also use the property management system to communicate with servicing companies, inspection companies, and the one or more building managers and/or superintendents.

The present disclosure provides various advantages for the management and organization of various property data and management tasks. For example, a single property management system is implemented that allows for a property owner and building manager to easily communicate with an inspection company and service company. In addition, the present system may allow for each user of the system to see real-time status updates, schedules, pending orders, outstanding balances among tenants and service and inspection companies, etc.

The present disclosure is also advantageous by allowing all property history and data to be stored in a single place and thereby may be easily accessible to users. This data includes service and inspection history associated with a given property and also Assets associated with a user and/or the property. This data continues to be accessible even after a relinquishment or transfer of ownership of the property or asset.

Where this application has listed the steps of a method or procedure in a specific order, it may be possible, or even expedient in certain circumstances, to change the order in which some steps are performed, and it is intended that the particular steps of the method claims set forth herein not be construed as being order-specific unless such order specificity is expressly stated in the claim.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

1. A property management system, comprising:
a memory for storing property data received from a plurality of users;
the property data including a description data of a real property, asset data of assets associated with the real property, and document data of documents associated with the real property;
the plurality of users including at least two of an owner, a real property manager, a tenant, an inspector, and a service worker;
a processor connected to the memory, the processor configured to:
determine if a user of the plurality of users is an authorized user based on credentials input by the user; and
when the user is an authorized user, identify a predetermined access level associated with the user, and provide the user access to the property data of the property management system, the access being consistent with the predetermined access level associated with the user.

2. The property management system of claim 1, further comprising:
an input device,
wherein the processor is further configured to:
receive from the input device property data from the authorized user; and
store the received property data in the memory.

3. The property management system of claim 1,
wherein the description data includes at least one of a legal description of the real property, street address of the real property, GPS coordinates of the real property, square footage of the real property, and tax information of the real property;
wherein the asset data includes information associated with individual assets including at least one of make, model, serial number, description, photograph, video, and location; and
wherein the document data includes image data for at least one of a deed, mortgage document, lease, and insurance document.

4. The property management system of claim 1,
wherein the property data further includes management information; and
wherein the processor is further configured to:
receive management information including rent information, lease information, tenant information; and
store the management information in the memory.

5. The property management system of claim 1, further comprising:
a display,
wherein the processor is further configured to:
receive from the authorized user a command to generate a report including some or all of the real property data; and
display on the display the report.

6. The property management system of claim 1, wherein the asset data includes information about one or more fixtures associated with the real property.

7. The property management system of claim 6, wherein the processor is further configured to:
identify a plurality of units within a building associated with the real property; and
associate management data with each unit of the plurality of units, the management data includes at least one of tenant data, rental data, unit data, and information of the one or more fixtures.

8. The property management system of claim 1, wherein the asset data includes information about one or more fixtures associated with the real property, the property management system further comprising:
associating each one of the one or more fixtures with particular rooms or units within a building of the real estate property, the associating is based on which room or unit each one of the one or more fixtures is located within.

9. The property management system of claim 8, further comprising:
an input device,
wherein the processor is further configured to:
receive from the input device a new geographical address from the authorized user;
store the received property data in the memory; and
re-associate asset data previously associated with the authorized user to the new geographical address.

10. The property management system of claim 1, wherein each user of the plurality of users are associated with a client device, and when accessing the property management system, the authorized user at least one of transmits or receives a message from another authorized user of the plurality of users.

11. The property management system of claim 1, wherein the asset data includes chattel information about one or more chattel owned by a chattel owner and associated with the real property, the property management system further comprising:
providing access to the chattel information based on an access level set by the chattel owner.

12. A property management system, comprising:
a server connected to a network, the server including a memory for storing property data and a processor, the property data including description data of the real property, asset data of assets associated with the real property, and document data of documents associated with the real property;
a plurality of client devices connected to the network, the client devices configured to access the property data stored in the server by a user of a plurality of users,
the processor associated with the server configured to:
determine if a user is an authorized user based on credentials input by the user; and
when the user is an authorized user, identify a predetermined access level associated with the user, and provide the user access to the property data of the property management system, the access being consistent with the predetermined access level associated with the user.

13. The property management system of claim 12, further comprising:
an input device associated with one of the plurality of client devices;
wherein the processor is further configured to:
receive from the input device property data from the authorized user; and
store the received property data in the memory.

14. The property management system of claim 12,
wherein the description data includes at least one of a legal description of the real property, street address of the real property, GPS coordinates of the real property, square footage of the real property, and tax information of the real property;
wherein the asset data includes information associated with individual assets including at least one of make, model, serial number, description, photograph, video, location; and
wherein the document data includes image data for at least one of a deed, mortgage document, insurance document.

15. The property management system of claim 12,
wherein the property data further includes management information; and
wherein the processor associated with the server is further configured to:
receive management information including rent information, lease information, tenant information; and
store the management information in the memory.

16. The property management system of claim 12, further comprising:
a display,
wherein the processor is further configured to:
receive from a user a command to generate a report including some or all of the real property data; and
display on the display the report.

17. The property management system of claim 12, wherein the asset data includes chattel information about one or more chattel owned by a chattel owner and associated with the real property, the property management system further comprising:
providing access to the chattel information based on an access level set by the chattel owner:

18. A method for managing property information, comprising the steps of:
storing, using a processor, property data received from a plurality of users, wherein the property data including a description data of the real property, asset data of assets associated with the real property, and document data of documents associated with the real property, and wherein the plurality of users including at least two of an owner, an authorized representative, a real property manager, a tenant, an inspector, and a service worker;
determining, using the processor, if a user is an authorized user based on credentials input by the user; and
when the user is an authorized user, identifying, using the processor, a predetermined access level associated with the user, and providing the user access to the property data of the property management system, the access being consistent with the predetermined access level associated with the user.

19. The method for managing property information of claim 18, further comprising:
receiving from the input device property data from the user; and
storing the received property data in a memory.

20. The method for managing property information of claim 18,
wherein the description data includes at least one of a legal description of the real property, street address of the real property, GPS coordinates of the real property, square footage of the real property, and tax information of the real property;
wherein the asset data includes information associated with individual assets including at least one of make, model, serial number, description, photograph, video, and location; and
wherein the document data includes image data for at least one of a deed, mortgage document and insurance document.

21. The method for managing property information of claim 18, wherein the property data further includes management information;
wherein the plurality of users further includes a real property manager; and
wherein the processor is further configured to:
receive management information including rent information, lease information, tenant information; and
store the management information in the memory.

22. The method for managing property information of claim 18, further comprising:
a display,
wherein the processor is further configured to:
receive from the authorized user a command to generate a report including some or all of the real property data; and
display on the display the report.

23. The method for managing property information of claim 18, wherein the asset data includes information about one or more fixtures associated with the real property.

24. The method for managing property information of claim 23, Wherein the processor is further configured to:
identify a plurality of units within a building associated with the real property; and
associate management data with each unit of the plurality of units, the management data includes at least one of tenant data, rental data, unit data, and information of the one or more fixtures.

25. The method for managing property information of claim 18, wherein the asset data includes information about one or more fixtures associated with the real property, the method further comprising:
associating each one of the one or more fixtures with a particular room, location, or unit within a building of the real estate property, the associating is based on which room, location, or unit each one of the one or more fixtures is located within.

26. The method for managing property information of claim 16, wherein the asset data includes information associated with individual assets including at least one of make, model, serial number, description, photograph, video, and location, the method further comprising:
transmitting, from a server, a communication to a client device used by a user, the communication being related to the asset data.

27. The method for managing property information of claim 26, wherein the asset data includes information about one or more fixtures, and the communication relate to the one or more fixtures.

28. The method for managing property information of claim 18, wherein the asset data includes chattel information about one or more chattel owned by a chattel owner and associated with the real estate property, further comprising:
providing access to the chattel information based on an access level set by the chattel owner:

29. A method for managing property information, comprising the steps of:
storing, using a processor, property data, wherein the property data includes at least one of a description data of the real property, asset data of assets associated with the real property, and document data of documents associated with the real property;
determining, using the processor, if a first user is an authorized user based on credentials input by the first user;
determining, using the processor, if a second user is an authorized user based on credentials input by the second user; and
when a first or second user is an authorized user, identifying, using the processor, a predetermined access level associated with the first or second user, and providing the first or second user access to the property data of the property management system, the access being consistent with the predetermined access level associated with the first or second user.

30. The method for managing property information of claim 29, further comprising:
receiving from an input device property data from the authorized user; and
storing the received property data in a memory.

31. The method for managing property information of claim 29, wherein the first user is at least one user selected from a first group of users consisting of an owner or an authorized representative of the owner.

32. The method for managing property information of claim 29, wherein the second user is at least one user selected from a second group of users consisting of a real property manager, a tenant, an inspector, or a service worker.

33. The property management system of claim 1, wherein a representative is authorized by at least one of the owner, the real property manager, the tenant, the inspector, and the service worker.

34. The property management system of claim 12, wherein the plurality of users includes at least two of an owner, a real property manager, a tenant, an inspector, and a service worker.
